(19) United States
(12) Patent Application Publication
(10) Pub. No.: US 2022/0079398 A1
(43) Pub. Date: Mar. 17, 2022

(54) Potty Training Apparatus

(71) Applicant: Stephanie Ann Green, Milwaukie, OR (US)

(72) Inventor: Stephanie Ann Green, Milwaukie, OR (US)

(21) Appl. No.: 17/019,305

(22) Filed: Sep. 13, 2020

(51) Int. Cl. A47K 17/00; G09B 19/00

(52) U.S. Cl. CPC A47K 17/00; G09B 19/0076

(57) ABSTRACT

The present invention is new art with a new function and is comprised of a potty-training apparatus for adults or children that temporarily clips onto the toilet seat and provides an ornamental target (target has a hole through it) that boys aim and pee through and urine goes directly into the toilet to be flushed.

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### JOINT RESEARCH AGREEMENT

This is not a joint research agreement and the only inventor is Stephanie Green.

### INCORPORATED BY REFERENCE OF MATERIAL

This section is non-applicable to this patent application as there is no material incorporated by reference.

### PRIOR DISCLOSURES BY INVENTOR

There are no prior disclosures by the inventor.

### BACKGROUND OF THE INVENTION

This is an invention in which no patents or ideas already exist. The invention relates to the field of novelty items or children's toys or tools for potty training. In particular, the invention relates to toilet training devices for adults and children and is considered a potty-training tool for children or novelty item for adults. The adult or child stands in front of the toilet, aims and pees into the one of the target holes. The item simply suction cups onto the toilet seat whereby the target is directly over the toilet water, so when the adult or child pees, the urine fall directly into the toilet.

There is no related art or information needed to be disclosed pursuant to 37 CFR 1.97 and 1.98 that is like this patent application. This invention is unique and through market research nothing similar was discovered. In addition, a prior USPTO search was conducted on www.uspto.gov and no similar patents were found.

Various prior art patents describe targets of various sorts that are used to direct a male in where to urinate. Kreiss, U.S. Pat. No. 4,044,405, teaches a target that is designed to be fixedly attached on a rigid arm, to a urinal or toilet. Lauer, U.S. Pat. No. 6,183,850, teaches a water-dispersible foam polymer target that floats in a toilet or rests in a urinal. Henoch et al., U.S. Pat. No. 2,703,407, teaches a spinner-target that is attached to a toilet with a rigid mounting structure; and includes a swing arm that supports the target.

### SUMMARY OF THE INVENTION

According to a first aspect of the invention, a toilet training device includes a target that is ornamental in nature and used to attract adults and children to aim and pee through the target; the target has a complete opening that allows urine to fall directly into the toilet; the target is temporarily attached to the back side of the toilet by means of a suction cup or clip. The present invention is developed to aid non-potty-trained children to urinate in a toilet directly or used as a novelty item for adults. In this regard, this toilet training device is a target device that will provide the adult or child with a focal point in the toilet to target when the user urinates.

### DESCRIPTION OF THE DRAWING

FIG. 01 is a side view of the potty-training apparatus.

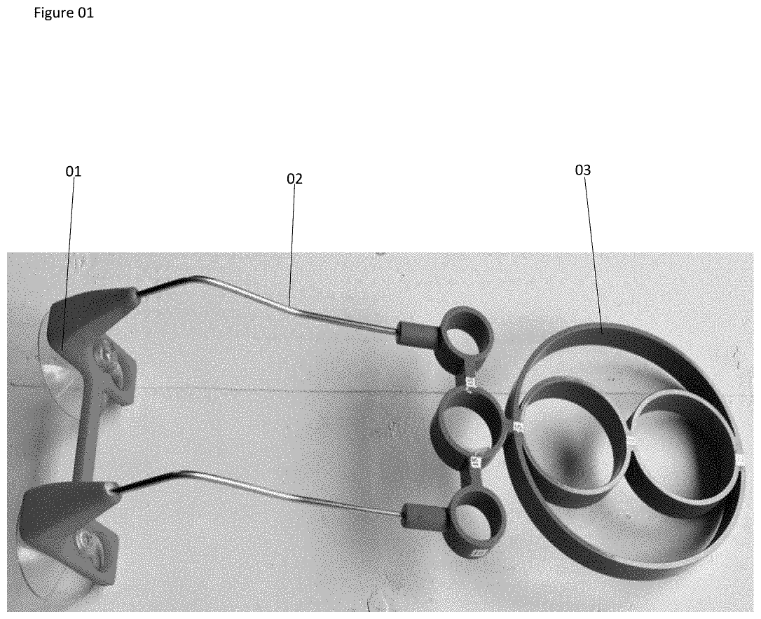

### DETAILED DESCRIPTION OF THE INVENTION

01=This is the part of the potty-training apparatus that clips onto the toilet seat. It is a simple clip or suction cup.

02=This part is the attachment that attaches the target to the suction cup.

03=This part is the ornamental target where the user aims for.

1. A potty toilet training apparatus comprising of: an ornamental target that has several open circles; the ornamental target has an attachment that attaches the target to the toilet bowl; the attachment piece is temporarily mounted to the toilet seat by means of a clip or suction cup; and the ornamental target location is directly above the toilet bowl whereby when the user urinates into the target, the urine falls directly into the toilet bowl after passing through the target.
